(19) United States
(12) Patent Application Publication
(10) Pub. No.: US 2011/0056438 A1
(43) Pub. Date: Mar. 10, 2011

(54) PUPPY CUP

(76) Inventor: ANNE EDLIN, Hunnewell, MO (US)

(21) Appl. No.: 12/875,684

(22) Filed: Sep. 3, 2010

Related U.S. Application Data
(60) Provisional application No. 61/239,793, filed on Sep. 4, 2009.

(51) Int. Cl. A01K 29/00

(52) U.S. Cl. 119/72

(57) ABSTRACT

Container for holding liquid for a pet to drink includes a generally round and hollow lower container portion having for retaining a first portion of such liquid. A generally round ledge portion connected to and formed integrally with said lower container portion and extending outwardly from an upper edge of the lower container portion is provided. A bottom surface of he ledge portion being adapted to rest on a surface surrounding such vehicle cup holder. Also provided is a generally round hollow container upper portion connected, adjacent a bottom edge thereof, to and formed as a single piece with the ledge portion adjacent an outer perimeter thereof. The upper portion includes a wall portion extending upwardly from said bottom edge thereof for a second predetermined height and having each of a third predetermined inner and outer diameter which is greater than a predetermined inner and outer diameter adjacent the outer perimeter of the ledge portion.

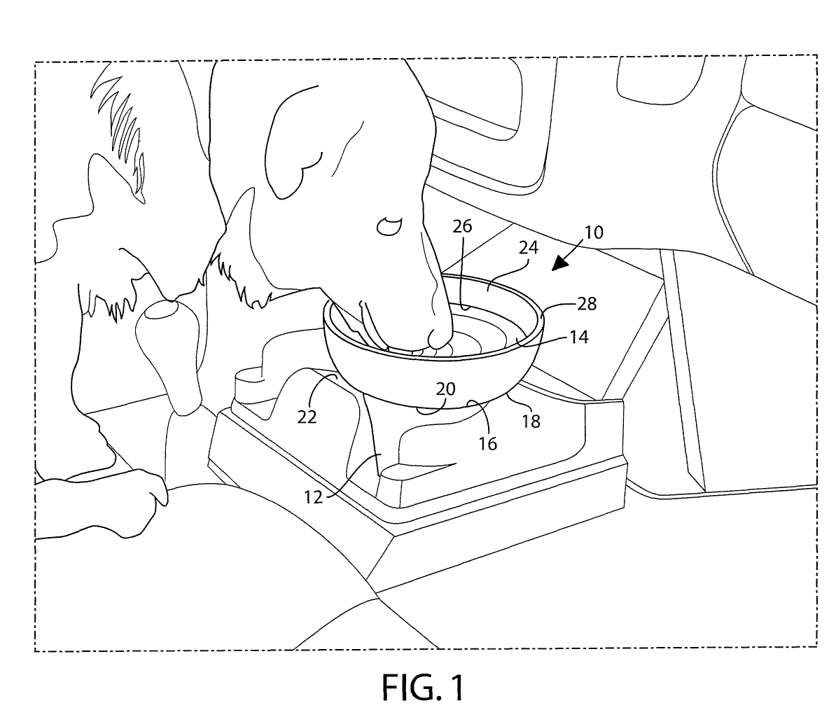

### CROSS REFERENCE TO RELATED APPLICATION

This application is closely related to and claims benefit from U.S. Provisional Patent Application Ser. No. 61/239,793 filed on Sep. 4, 2009.

### FIELD OF THE INVENTION

The present invention relates, in general, a container for maintaining a supply of fresh water for an animal to drink and, more particularly, this invention relates to a cup for use in an automobile cup holder which will resist being upset.

### BACKGROUND OF THE INVENTION

Prior to the conception and development of the present invention, as is generally well known the prior art, when taking a pet on a trip a bowl, containing water, is normally placed on the floor of a vehicle for the pet to drink.

Such practice, as is also well known in the prior art, oftentimes leads to the water being spilt onto the carpet of the car. The water in the bowl may be spilt either by the pet or the by movement of the vehicle. Over time this will lead to the deterioration of the carpet by rotting and/or mildewing. Additionally, this spilt water may cause stains to develop in the carpet. In either case, the resale value of the vehicle is lowered.

On the other hand it is very important to keep the pet well hydrated, particularly, in the hot summer months. In order to do this the pet owner must make frequent stops to allow the pet to drink.

### SUMMARY OF THE INVENTION

The present invention provides a container holding a predetermined amount of fluid for a pet to drink, which can be securely positioned in the cup holder of a vehicle and thereby resist being turned over or being pushed under the vehicle seat by the pet. The container includes a generally round and hollow lower container portion having each of a first predetermined outer and inner diameter, a first predetermined height and a first predetermined thickness, the hollow lower container portion has a bottom wall portion for retaining a first portion of such liquid. A generally round ledge portion is connected to and formed integrally with the lower container portion and extends outwardly from an upper edge of said lower container portion. The ledge portion has each of a second predetermined diameter adjacent an outer perimeter thereof and a second predetermined thickness, a bottom surface of the ledge portion being adapted to rest on a surface surrounding such vehicle cup holder. There is also a generally round hollow container upper portion connected, adjacent a bottom edge thereof, to and formed as a single piece with said ledge portion adjacent said outer perimeter of said ledge portion. The upper portion has of a second predetermined outer and inner diameter. The upper portion includes a wall portion which extends upwardly from the bottom edge thereof for a second predetermined height. The wall portion has each of a third predetermined inner and outer diameter which is greater than the second predetermined inner and outer diameter adjacent the outer perimeter of the ledge portion.

### OBJECTS OF THE PRESENT INVENTION

It is, therefore, a primary object of the present invention to provide a container for holding a liquid which will resist tipping by a pet drinking such liquid contained therein while traveling in a vehicle.

Another object of the present invention is to provide a container which can be manufactured using a variety of materials and in a variety of colors.

Still another object of the present invention is to provide a container which will minimize having to stop and give a pet fluid to drink while traveling.

Yet another object of the present invention is to provide a container which will substantially minimize damage to carpeting and seats in a vehicle from spilled fluids.

A further object of the present invention is to provide a container which is relatively inexpensive to manufacture either in a mold using plastic or as a stamping using a pre-selected metal.

In addition to the several objects and advantages of the present invention which have been described above in some specific detail it should be noted that various other objects and advantages of the present invention will become more readily recognized from the following more detailed description of the invention.

### BRIEF DESCRIPTION OF THE DRAWING

The single FIGURE is a perspective view showing the container inserted into an automobile cup holder.

### BRIEF DESCRIPTION OF A PRESENTLY PREFERRED EMBODIMENT OF THE INVENTION

Now referring, more particular, to the drawing wherein there is illustrated a container, generally designated 10, for holding a predetermined amount of liquid (not shown) for a pet to drink. The container 10 includes a generally round and hollow lower container portion 12 having each of a first predetermined outer and inner diameter, a first predetermined height and a first predetermined thickness.

The first predetermined outer diameter is generally between about 2.75 inches and 3.0 inches. Preferably, such outer diameter is about 3.0 inches to provide a slightly closer fit.

The hollow lower container portion 12 includes a bottom wall portion (not shown) for retaining a first portion of such liquid therein.

There is also a generally round ledge portion 14 connected to and formed integrally with the lower container portion 12.

Such ledge portion 14 extends outwardly from an upper edge 16 of the lower container portion 12 and has each of a second predetermined diameter adjacent an outer perimeter 18 thereof and a second predetermined thickness. A bottom surface 20 of the ledge portion 14 is adapted to at least partially rest on a surface 22 surrounding the vehicle cup holder 10.

Additionally, there is a generally round hollow container upper portion 24 connected, adjacent a bottom edge 26 thereof, to and formed as a single piece with the ledge portion 14 adjacent the outer perimeter 18 of the ledge portion 14 and having each of a second predetermined outer and inner diameter. The upper portion 24 includes a wall portion 28 extending upwardly from the bottom edge 26. The wall portion 28 has each of a third predetermined inner and outer diameter which is greater than the second predetermined inner and outer diameter adjacent of the outer perimeter 18 of ledge portion 14.

In the presently preferred embodiment of the invention the overall height of the container 10 is about 4.5 inches.

I claim:

1. A container for holding a predetermined amount of liquid for a pet to drink said container comprising:
a) a generally round and hollow lower container portion having each of a first predetermined outer and inner diameter, a first predetermined height and a first predetermined thickness, said hollow lower container portion including a bottom wall portion for retaining a first portion of such liquid;
b) a generally round ledge portion connected to and formed integrally with said lower container portion and extending outwardly from an upper edge of said lower container portion and having each of a second predetermined diameter adjacent an outer perimeter thereof and a second predetermined thickness, a bottom surface of said ledge portion being adapted to rest on a surface surrounding such vehicle cup holder;
c) a generally round hollow container upper portion connected, adjacent a bottom edge thereof, to and formed as a single piece with said ledge portion adjacent said outer perimeter of said ledge portion and having each of a second predetermined outer and inner diameter, said upper portion includes a wall portion extending upwardly from said bottom edge thereof for a second predetermined height and having each of a third predetermined inner and outer diameter which is greater than said second predetermined inner and outer diameter adjacent said outer perimeter of said ledge portion.

2. A container, according to claim 1, wherein said first predetermined diameter of said lower container portion is generally between about 2.57 inches and 3.0 inches.

3. A container, according to claim 2, wherein said first predetermined diameter of said lower container portion is about 3.0 inches.

4. A container, according to claim 1, wherein an overall height of said container is between about 4.0 inches and a bout 5.0 inches.

5. A container, according to claim 1, wherein an overall height of said container is about 4.5 inches.
